(19) United States
(12) Patent Application Publication
(10) Pub. No.: US 2018/0336613 A1
(43) Pub. Date: Nov. 22, 2018

(54) SYSTEM AND METHOD FOR MANAGING LIMIT ORDERS

(71) Applicant: MZ IP Holdings, LLC, Palo Alto, CA (US)

(72) Inventors: William James Pyne, Santa Clara, CA (US); Jeremy Emerson, Gilroy, CA (US)

(21) Appl. No.: 15/973,985

(22) Filed: May 8, 2018

Related U.S. Application Data
(60) Provisional application No. 62/507,321, filed on May 17, 2017.

(51) Int. Cl. G06Q 30/06; G06Q 30/02

(52) U.S. Cl. CPC G06Q 30/0617; G06Q 30/0201; G06Q 30/0625

(57) ABSTRACT

A method, a system, and an article are provided for managing limit orders. An example computer-implemented method can include: receiving an identification of (i) at least one item for purchase in one or more online stores and (ii) a maximum purchase price for the at least one item; receiving a current price for the at least one item on one or more channels of a plurality of channels of a publish-subscribe system; determining a monitoring frequency for the at least one item based on a rate of change in a price history of the at least one item; monitoring the current price for the at least one item in the one or more online stores based on the monitoring frequency; and automatically purchasing the at least one item when the current price is at or below the maximum purchase price.

### CROSS-REFERENCE TO RELATED APPLICATIONS

This application claims the benefit of U.S. Provisional Patent Application No. 62/507,321, filed May 17, 2017, the entire contents of which are incorporated by reference herein.

### BACKGROUND

The present disclosure relates generally to computer-implemented purchases of goods and services and, in some examples, to systems and methods for managing limit orders for such purchases.

The number of consumers who purchase goods and services online has increased dramatically in recent years, upending traditional (e.g., brick and mortar) forms of retail. One shopping pattern that has not changed in online environments is the habit of consumers to continue to search for sales or special deals or otherwise the lowest price for purchasing a particular good or service. Consumers can spend inordinate amounts of time waiting for a sale that meets their particular purchase criteria (e.g., price and/or quantity). Conventionally, consumers are required to continually search and monitor online shopping websites to wait for the desired goods or services to meet their purchase criteria. Even with continual searching and monitoring, however, it is possible that a sale will be missed, because, for example, the consumer was not viewing a website at the correct time, the website was unavailable, and/or overwhelming demand resulted in the good or service being out of stock.

### SUMMARY

Implementations of the subject matter described herein relate to computer-implemented systems and methods for managing limit orders for electronically purchasing goods and/or services in online or in-app shopping environments. A user can specify a limit order, including, for example, a price and a quantity for a desired good and/or service in any suitable online shopping website or collection of online shopping websites. The user is not required to continually view or otherwise monitor any online shopping website or in-app marketplace, but can be notified automatically when the limit order is fulfilled (or has expired). When the desired goods and/or services meet (or beat) the specified criteria of the limit order, the goods and/or services can be automatically purchased on behalf of the user and, if desired, automatically shipped to the user. Such limit orders can be specified and remain valid for a particular time period (e.g., a certain number of minutes, hours, days, weeks, months, etc. or until a specified expiration time/date) or remain open indefinitely until fulfilled, depending on the needs of the user. Exemplary embodiments can be used in any suitable online or other electronic shopping website or in any appropriate in-app marketplace (e.g., available in an application for an online game) to facilitate an efficient and convenient shopping experience for the user.

Advantageously, the systems and methods described herein can make it significantly easier for users to acquire goods and services at desired prices, without having to manually search for or monitor online price information. Additionally or alternatively, when user-specified prices are shared with sellers (e.g., an online retailer or merchant), the sellers can use the price information to determine user demand for goods and services. In some instances, a seller can sell an item to a user at the user's specified price, while maintaining a different (e.g., higher) price for other users.

The systems and methods described herein are able to achieve improvements in computer functionality. For example, when thousands or millions of users have placed a limit order for a particular item (or multiple items), the systems and methods described herein are able to monitor the price of the item on behalf of all the users. This avoids the need for each user to check the price individually and can achieve a significant reduction in network traffic. The approach can also reduce CPU usage and power consumption on one or more server computers and/or client devices, given that the price can be monitored with fewer devices (e.g., by a single server computer). Such advantages can be particularly significant when there are thousands or millions of items being monitored for thousands or millions of users. Likewise, in some instances, the systems and methods described herein can improve computational efficiencies associated with currency conversions. Rather than converting price information to a different currency separately for each user, for example, the systems and methods can do a single currency conversion for many users, all at once.

In one aspect, the subject matter described in this specification relates to a computer-implemented method. The method includes: receiving, from a client device, an identification of at least one item for purchase in one or more online stores; receiving, from the client device, an identification of a maximum purchase price for the at least one item; receiving, using at least one computer processor, a current price for the at least one item on one or more channels of a plurality of channels of a publish-subscribe system, wherein the current price for the at least one item is published to the one or more channels by the one or more online stores; determining, using the at least one computer processor, a monitoring frequency for the at least one item based on a rate of change in a price history of the at least one item; monitoring, using the at least one computer processor, the current price for the at least one item in the one or more online stores based on the monitoring frequency; and automatically purchasing, using the at least one computer processor, the at least one item when the current price is at or below the maximum purchase price.

In certain examples, the at least one item can include items of different types, and the maximum purchase price can be received for each of the items. The items can be automatically purchased when the current price for each item is at or below the maximum purchase price of each item. The method can include predicting, using the at least one computer processor, when the at least one item will be automatically purchased based on the rate of change in the price history of the at least one item. Automatically purchasing the at least one item can include debiting an account associated with the client device.

In some implementations, receiving the identification of the maximum purchase price can include receiving an authorization to charge the maximum purchase price to an account associated with the client device. Receiving the identification of the at least one item can include receiving an identification of a quantity of the at least one item. Automatically purchasing the at least one item can include automatically purchasing the identified quantity of the at least one item. The current price can be or include an average price for the identified quantity of the at least one item. Automatically purchasing the identified quantity of the at least one item can include automatically purchasing the identified quantity of the at least one item from more than one online store.

In another aspect, the subject matter described in this specification relates to a system. The system includes one or more computer processors programmed to perform operations including: receiving, from a client device, an identification of at least one item for purchase in one or more online stores; receiving, from the client device, an identification of a maximum purchase price for the at least one item; receiving, using at least one computer processor, a current price for the at least one item on one or more channels of a plurality of channels of a publish-subscribe system, wherein the current price for the at least one item is published to the one or more channels by the one or more online stores; determining, using the at least one computer processor, a monitoring frequency for the at least one item based on a rate of change in a price history of the at least one item; monitoring, using the at least one computer processor, the current price for the at least one item in the one or more online stores based on the monitoring frequency; and automatically purchasing, using the at least one computer processor, the at least one item when the current price is at or below the maximum purchase price.

In certain instances, the at least one item can include items of different types, and the maximum purchase price can be received for each of the items. The items can be automatically purchased when the current price for each item is at or below the maximum purchase price of each item. The operations can include predicting, using the at least one computer processor, when the at least one item will be automatically purchased based on the rate of change in the price history of the at least one item. Automatically purchasing the at least one item can include debiting an account associated with the client device.

In some examples, receiving the identification of the maximum purchase price can include receiving an authorization to charge the maximum purchase price to an account associated with the client device. Receiving the identification of the at least one item can include receiving an identification of a quantity of the at least one item. Automatically purchasing the at least one item can include automatically purchasing the identified quantity of the at least one item. The current price can be or include an average price for the identified quantity of the at least one item. Automatically purchasing the identified quantity of the at least one item can include automatically purchasing the identified quantity of the at least one item from more than one online store.

In another aspect, the subject matter described in this specification relates to an article. The article includes a non-transitory computer-readable medium having instructions stored thereon that, when executed by one or more computer processors, cause the computer processors to perform operations including: receiving, from a client device, an identification of at least one item for purchase in one or more online stores; receiving, from the client device, an identification of a maximum purchase price for the at least one item; receiving, using at least one computer processor, a current price for the at least one item on one or more channels of a plurality of channels of a publish-subscribe system, wherein the current price for the at least one item is published to the one or more channels by the one or more online stores; determining, using the at least one computer processor, a monitoring frequency for the at least one item based on a rate of change in a price history of the at least one item; monitoring, using the at least one computer processor, the current price for the at least one item in the one or more online stores based on the monitoring frequency; and automatically purchasing, using the at least one computer processor, the at least one item when the current price is at or below the maximum purchase price.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for managing limit orders for computer-implemented online shopping.

FIG. 2 is a schematic diagram of an example system and method for managing limit orders for computer-implemented online shopping.

FIG. 3 is a flowchart of an example method of automatically purchasing one or more items using a limit order.

### DETAILED DESCRIPTION

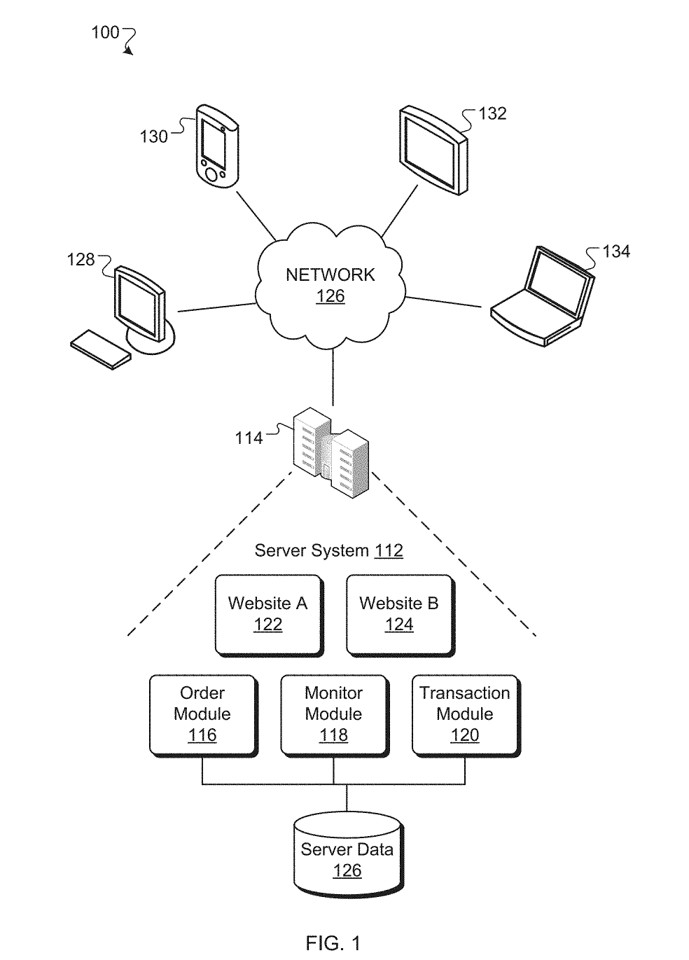

FIG. 1 illustrates an example system 100 for managing limit orders in an online marketplace. A server system 112 provides functionality for monitoring price information and automatically purchasing items when a price threshold is satisfied. The server system 112 includes software components and databases that can be deployed at one or more data centers 114 in one or more geographical locations, for example. The server system 112 software components can include an order module 116, a monitor module 118, a transaction module 120, a website A 122, and a website B 124. The software components can include subcomponents that can execute on the same or on different individual data processing apparatus. The server system 112 databases can include a server data 126 database. The databases can reside in one or more physical storage systems. The software components and data will be further described below.

A software application, such as, for example, a web-based application, can be provided as an end-user application to allow users to interact with the server system 112. The software application can relate to and/or provide a wide variety of functions and information, including, for example, entertainment (e.g., a game, music, videos, etc.), business (e.g., word processing, accounting, spreadsheets, etc.), news, weather, finance, sports, etc. The software application can be accessed through a network 126 (e.g., the Internet) by users of client devices, such as a personal computer 128, a smart phone 130, a tablet computer 132, and a laptop computer 134. Other client devices are possible. Additionally or alternatively, software components for the system 100 (e.g., the order module 116, the monitor module 118, and/or the transaction module 120) or any portions thereof can reside on or be used to perform operations on one or more of the client devices.

FIG. 1 depicts the order module 116, the monitor module 118, and the transaction module 120 as being able to communicate with the server data 126 database. The server data 126 database generally includes information related to the software application and/or the server system 112, including, for example, user data, product data, website data, account data, image data, video data, and content data. In alternative examples, the server data 126 database or any portion thereof can be stored on one or more client devices.

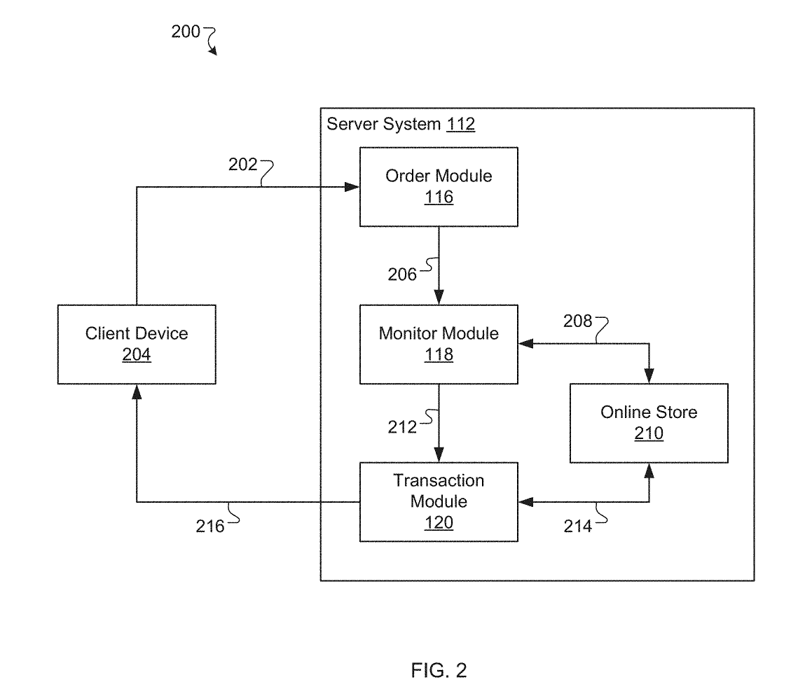

Referring to FIG. 2, in various instances, the order module 116, the monitor module 118, and the transaction module 120 are or include software components configured to automatically purchase goods and services for users of client devices. In an example method 200, the order module 116 can receive (step 202) an order from a client device 204 (e.g., the smart phone 130) to purchase a particular item (e.g., a good or a service) when a price for the item drops below or satisfies a certain threshold or maximum purchase price. The order can be generated by a user of the client device 204 and can be referred to herein as a “limit order,” for example, given that the order can limit or place restrictions on price. After receiving the limit order, the order module 116 can communicate (step 206) the item and price information to the monitor module 118. The monitor module 118 can monitor (step 208) price information for the item on at least one online store 210 (e.g., the website A 122 and/or the website B 124). When the maximum purchase price is satisfied, the monitor module 118 can instruct (step 212) the transaction module 120 to purchase the item from the online store 210. The transaction module 120 can complete (step 214) the purchase, for example, by providing the online store 210 with information related to an account associated with the client device 204. The transaction module 120 can inform (step 216) the client device 204 that the purchase has been completed.

In various examples, the limit order can include criteria such as, for example, an identification of the item to be purchased (e.g., a good, a service, or an in-app item) along with a desired quantity and/or a price that the user is willing to pay for the item. The limit order can also include an expiration time and/or date, such as a length of time that the limit order will be valid or a specific time or date at which the limit order will expire. If no expiration criteria is specified, then the limit order can last indefinitely, until fulfilled or canceled by the user. Additionally or alternatively, the limit order can include a payment method, a shipping address, and/or a shipping method, which can be specified by the user before, during, and/or after the limit order is placed (e.g., any time before the limit order is fulfilled). Once the limit order is finalized and processed by the order module 116, the limit order can proceed to a criteria matching stage where the monitor module 118 can determine if the limit order criteria are satisfied.

At the criteria matching stage, the monitor module 118 can monitor information available in one or more online stores (e.g., the online store 210) and compare the information to the limit order criteria. As long as one or more of the criteria are not satisfied, the monitor module 118 can continue monitoring the online stores and retain the limit order for deferred fulfillment. For example, the monitor module 118 can check the online stores periodically (e.g., each second, minute, hour, or day) to look for any changes in price, inventory level, or other information for the desired item. Once the limit order criteria are satisfied, the limit order can proceed to a fulfillment stage where the transaction module 120 can complete the purchase of the item.

At the fulfillment state, the transaction module 120 can complete the purchase of the item from the online stores at a price that is at or below the maximum price specified in the limit order. The transaction module 120 can send a notification to the client device 204 (e.g., an email and/or a text message) informing the user that the limit order has been fulfilled. In some instances, if the user's payment method includes insufficient funds, the limit order can be canceled or at least placed on hold or otherwise held in abeyance pending entry of a valid payment method. The purchased item can be automatically shipped to the user according to any shipping information (e.g., user address, shipping method, etc.) specified in the limit order.

In various implementations, a limit order can be withdrawn or canceled manually or automatically before the limit order is fulfilled. The server system 112 (e.g., using the monitor module 118 and/or the transaction module 120), for example, can cancel a limit order in any of the following circumstances: when the limit order has expired, the user account is fraudulent/invalid, the user's payment method includes insufficient funds or is invalid, the shipping address is invalid, and/or the item is discontinued or otherwise no longer available for purchase. Other situations or circumstances may warrant cancellation of a limit order. Alternatively or additionally, instead of canceling a limit order, the limit order can be placed on hold or suspended to give the user a chance to rectify any issues pertaining to the limit order. In such a scenario, the server system 112 can send a notification to the client device 204 (e.g., an email and/or a text message) informing the user that there is an issue with the limit order and asking the user to resolve the issue before the limit order can proceed.

In some examples, limit orders can be specified in a variety of ways to accommodate different buying preferences of users. For example, instead of purchasing a single item when a specified price for the item is satisfied, a limit order can instruct the server system 112 to purchase multiple items when an average price (or a median price) for the items is satisfied. This can increase the likelihood of fulfilling an order for multiple items, particularly in markets where goods or services are sold in smaller quantities by different parties or online stores (for example, in an auction).

Additionally or alternatively, a limit order can be extended to cover different types of items in a single order. In one example, a limit order for purchasing items A, B, and C can be satisfied only when a specified price for each item is satisfied. A limit order for a home entertainment system, for example, can be satisfied when a surround sound system is available at a first price point, a TV is available at a second price point, and a technician is available to install the equipment at a third price point. The three items may be purchased in such an instance only when all three price points are satisfied. Each item can be purchased from the same store or from different stores.

In some implementations, a limit order can be extended to apply coupons and/or promotion codes for one or more items specified in the limit order. This can effectively raise the price point required to fulfill the order without requiring the user to pay the higher price. In other words, the limit order in such an instance can be fulfilled when the current price minus a value of the coupon or promotion code is at or below the price specified in the limit order.

Additionally or alternatively, a user and/or the server system 112 can specify a currency associated with a limit order. This can allow the monitor module 118 to search online stores and perform currency conversions (e.g., using publicly available exchange rate information) across a wide variety of markets that use different currencies. When the item is available in another currency that satisfies the limit order, the monitor module 118 can account for the currency exchange and recognize that the limit order is satisfied.

In various instances, the limit order approach described herein can be implemented using a front-end web portal that can interact or exchange information with existing web portals or online stores operated by online retailers, manufacturers, and the like. The front-end web portal can allow users to place limit orders on existing online stores that do not otherwise utilize or permit limit orders. The front-end web portal can monitor the existing web portal for price and quantity changes using web scraping or similar techniques. For example, a web scraper can be used to scan a webpage on an online store for item, price, and/or quantity information. The web scraper can recognize price information, for example, by searching for numerical values and/or price symbols. The web scraper can recognize an item based on an item name or other identifier (e.g., a product number). Additionally or alternatively, the web scraper can determine a quantity remaining in inventory by searching for a numerical value in close proximity to certain keywords, such as “inventory” or “stock.”

Some existing web portals or online stores may not provide sale prices, shipping and handling charges, and/or sales tax (or value-added tax) information until the items have been added to a virtual shopping cart and/or the system proceeds to checkout. In such cases, the front-end web portal can add items to a shopping cart and/or proceed to checkout, as needed, and then scrape the sales prices, shipping and handling charges, and/or sales tax information from a resulting shopping cart page or checkout page. Additionally or alternatively, shipping and handling charges and/or sales taxes can vary depending on the shipping address, so the front-end portal can provide address information, as needed, to determine such charges, taxes, and/or an actual cost for purchase.

In some instances, the monitor module 118 can be used to predict trends and/or a time at which a limit order will be satisfied. For example, the monitor module 118 can periodically determine a price of an item on an online store and determine a price history for the item. The monitor module 118 can use the price history to predict future prices (e.g., using curve fitting, extrapolation, and/or machine learning). Such information can be used to predict when the limit order price may be satisfied in the future. Alternatively or additionally, the information can be used to determine how frequently the monitor module 118 should obtain updated price information from the online store. If the price is changing rapidly, for example, the monitor module 118 should check the price more frequently (e.g., every hour). If the price is changing slowly, the monitor module 118 can check the price less frequently (e.g., every day or week). In general, a frequency at which the monitor module 118 obtains information from an online store can be based on a rate at which the information is changing. In some instances, for example, the monitor module 118 can determine, based on a price history, that price information for an item on a website is updated at regular intervals (e.g., each hour or each day). The monitor module 118 can then check the price information at each interval, rather than performing more frequent price checks, thereby saving computer resources and/or reducing network traffic.

In various examples, the monitor module 118 is able to search for and retrieve information from multiple online stores. In effect, this can allow users to place limit orders that can be fulfilled by more than one online store. For example, a user can create a limit order without specifying a particular online store, and the monitor module 118 can then search or otherwise monitor any suitable number of online stores to determine if the limit order is satisfied. Once an online store is determined to satisfy the limit order, the item can be purchased from that online store. Price information can be obtained using one or more web scrapers or application programming interfaces.

When the monitor module 118 determines that a web portal or online store satisfies a limit order for an item, it can be preferable to purchase the item at that time (e.g., immediately), rather than continuing to search any remaining web portals and online stores (e.g., for a better price). This can be particularly true, for example, when a stock or a supply for the item is limited and/or when any remaining web portals or online stores have poor connectivity or are otherwise unresponsive. In such instances, a time limit or other constraint can be imposed that prevents the monitor module 118 from continuing to search for price information on the remaining web portals and online stores. The monitor module 118 can instead instruct the transaction module 120 to purchase the item from the web portal or online store that satisfies the limit order. This can avoid a lost opportunity to purchase the item at desirable conditions.

In certain implementations, when users create and submit limit orders using the systems and methods described herein, the limit order information can serve as feedback regarding the items users are looking to buy and the prices users are willing to pay. When such information is shared with sellers, for example, the sellers can use the information to generate sales without having to guess at a price point and/or lose out on revenue when users are willing to pay higher prices. Additionally or alternatively, sellers can attempt to satisfy a limit order for a user without making any changes for other users. For example, a seller can drop the price of an item for one user to satisfy a limit order while maintaining the price for any other users.

In some examples, the monitor module 118 can be extended to cover retailers, merchants, or manufacturers that do not have an online store. The monitor module 118 in such a case can automatically make phone calls to these entities to obtain product and price information. When the collected information satisfies a limit order, the associated item can be purchased automatically over the phone (e.g., using the transaction module 120).

The systems and methods described herein can be implemented using any suitable type of client device platform, such as mobile devices or desktop/laptop-style computer systems that are capable of accessing and interacting with online shopping websites or in-app marketplaces. Any suitable computer network (e.g., LAN, WAN, Internet, or the like) can be used to support the interaction of the user with the online shopping websites or in-app marketplaces using the appropriate device platform.

In preferred implementations, the systems and methods described herein can be implemented with a real-time platform that is capable of transmitting and processing large amounts of data at or near real-time with low latency. In some implementations, for example, the systems and methods can be implemented using SATORI®, a real-time platform from Machine Zone, Inc. Such an approach can utilize a publish-subscribe architecture in which one or more publishers can publish data on one or more channels, and one or more subscribers can access the data by subscribing to the one or more channels. In certain instances, for example, one or more online stores, retailers, wholesalers, merchants, and/or manufacturers can provide product and/or price information that is published on one or more channels of a publish-subscribe system. Such entities can publish the information directly and/or can provide the information to a separate entity and/or process that can publish the information. The monitor module 118 can subscribe to the one or more channels to be kept apprised of the latest product and/or price information. The transaction module 120 can purchase items when limit orders are satisfied, as described herein. An exemplary publish-subscribe system is described in U.S. patent application Ser. No. 15/442,036, filed Feb. 24, 2017, and titled “Selective Distribution of Messages in a Scalable, Real-Time Messaging System,” the entire disclosure of which is incorporated by reference herein.

For purposes of illustration and not limitation, Table 1 describes an example structure of how limit order data can be maintained in a suitable database. The data structure can be configured to allow a single item to be purchased at a given price using a default payment method associated with a user account. Multiple items can be managed through respective data entries. Such a data structure can assume that other corresponding supporting tables or data structures also exist, including, for example: a table/data structure having a payment method and a shipping address of the user; and an items table/data structure having item price and quantity in stock to track items in an online store. Other suitable data structures and supporting tables are possible.

TABLE 1
Example data structure for a limit order.

| Column Name | Data Type |
|---|---|
| limit_order_id (primary_key) | integer |
| user_id | integer |
| item_id | integer |
| Qty | integer |
| Price | currency |
| expiration_date | datetime |

The following is an example of pseudo code that can use the data structure of Table 1 to cleanup expired limit orders:

DELETE FROM LimitOrders

WHERE expiration_date<now( ).

The following is an example of pseudo code that can use the data structure of Table 1 to identify orders to fulfill:

SELECT *
FROM LimitOrders I
WHERE I.price < (

SELECT i.price * I.qty
FROM Inventory i
WHERE i.item_id = I.item_id
AND i.qty_in_stock > 1.qty) .

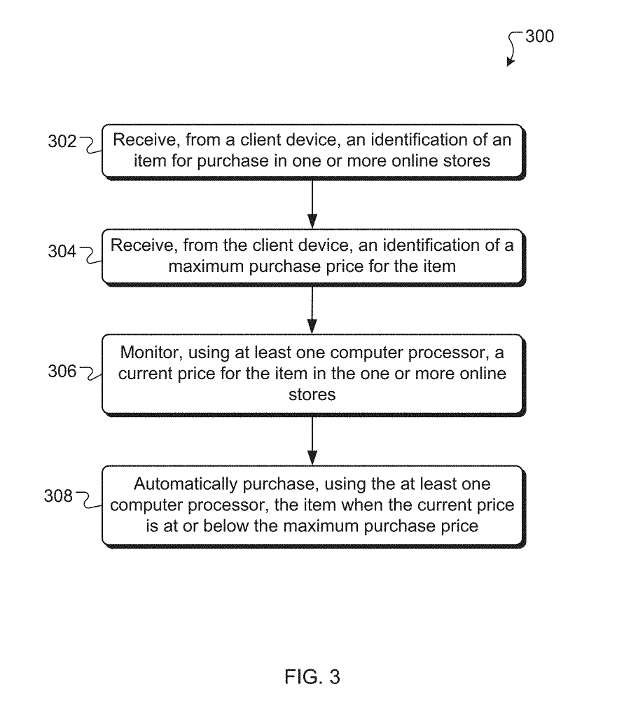

FIG. 3 illustrates an example computer-implemented method 300 for automatically purchasing items from an online store or marketplace. An identification of an item for purchase in one or more online stores is received (step 302) from a client device. An identification of a maximum purchase price for the item is received (step 304) from the client device. At least one computer processor is used to monitor (step 306) a current price for the item in the one or more online stores. The at least one computer processor is used to automatically purchase (step 308) the item when the current price is at or below the maximum purchase price.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
receiving, from a client device, an identification of at least one item for purchase in one or more online stores;
receiving, from the client device, an identification of a maximum purchase price for the at least one item;
receiving, using at least one computer processor, a current price for the at least one item on one or more channels of a plurality of channels of a publish-subscribe system,
wherein the current price for the at least one item is published to the one or more channels by the one or more online stores;
determining, using the at least one computer processor, a monitoring frequency for the at least one item based on a rate of change in a price history of the at least one item;
monitoring, using the at least one computer processor, the current price for the at least one item in the one or more online stores based on the monitoring frequency; and
automatically purchasing, using the at least one computer processor, the at least one item when the current price is at or below the maximum purchase price.

2. The method of claim 1, wherein the at least one item includes items of different types, and wherein the maximum purchase price is received for each of the items.

3. The method of claim 2, wherein the items are automatically purchased when the current price for each item is at or below the maximum purchase price of each item.

4. The method of claim 1, comprising:
predicting, using the at least one computer processor, when the at least one item will be automatically purchased based on the rate of change in the price history of the at least one item.

5. The method of claim 1, wherein automatically purchasing the at least one item comprises:
debiting an account associated with the client device.

6. The method of claim 1, wherein receiving the identification of the maximum purchase price comprises:
receiving an authorization to charge the maximum purchase price to an account associated with the client device.

7. The method of claim 1, wherein receiving the identification of the at least one item comprises:
receiving an identification of a quantity of the at least one item.

8. The method of claim 7, wherein automatically purchasing the at least one item comprises:
automatically purchasing the identified quantity of the at least one item.

9. The method of claim 8, wherein the current price comprises an average price for the identified quantity of the at least one item.

10. The method of claim 8, wherein automatically purchasing the identified quantity of the at least one item comprises:
automatically purchasing the identified quantity of the at least one item from more than one online store.

11. A system, comprising:
one or more computer processors programmed to perform operations comprising:
receiving, from a client device, an identification of at least one item for purchase in one or more online stores;
receiving, from the client device, an identification of a maximum purchase price for the at least one item;
receiving, using at least one computer processor, a current price for the at least one item on one or more channels of a plurality of channels of a publish-subscribe system,
wherein the current price for the at least one item is published to the one or more channels by the one or more online stores;
determining, using the at least one computer processor, a monitoring frequency for the at least one item based on a rate of change in a price history of the at least one item;
monitoring, using the at least one computer processor, the current price for the at least one item in the one or more online stores based on the monitoring frequency; and
automatically purchasing, using the at least one computer processor, the at least one item when the current price is at or below the maximum purchase price.

12. The system of claim 11, wherein the at least one item includes items of different types, and wherein the maximum purchase price is received for each of the items.

13. The system of claim 12, wherein the items are automatically purchased when the current price for each item is at or below the maximum purchase price of each item.

14. The system of claim 11, comprising:
predicting, using the at least one computer processor, when the at least one item will be automatically purchased based on the rate of change in the price history of the at least one item.

15. The system of claim 11, wherein receiving the identification of the maximum purchase price comprises:
receiving an authorization to charge the maximum purchase price to an account associated with the client device.

16. The system of claim 11, wherein receiving the identification of the at least one item comprises:
receiving an identification of a quantity of the at least one item.

17. The system of claim 16, wherein automatically purchasing the at least one item comprises:
automatically purchasing the identified quantity of the at least one item.

18. The system of claim 17, wherein the current price comprises an average price for the identified quantity of the at least one item.

19. The system of claim 17, wherein automatically purchasing the identified quantity of the at least one item comprises:
automatically purchasing the identified quantity of the at least one item from more than one online store.

20. An article, comprising:
a non-transitory computer-readable medium having instructions stored thereon that, when executed by one or more computer processors, cause the computer processors to perform operations comprising:
receiving, from a client device, an identification of at least one item for purchase in one or more online stores;
receiving, from the client device, an identification of a maximum purchase price for the at least one item;
receiving, using at least one computer processor, a current price for the at least one item on one or more channels of a plurality of channels of a publish-subscribe system,
wherein the current price for the at least one item is published to the one or more channels by the one or more online stores;
determining, using the at least one computer processor, a monitoring frequency for the at least one item based on a rate of change in a price history of the at least one item;
monitoring, using the at least one computer processor, the current price for the at least one item in the one or more online stores based on the monitoring frequency; and
automatically purchasing, using the at least one computer processor, the at least one item when the current price is at or below the maximum purchase price.
